(19) United States
(12) Patent Application Publication
(10) Pub. No.: US 2026/0006384 A1
(43) Pub. Date: Jan. 1, 2026

(54) LOUDSPEAKER

(71) Applicant: MERRY ELECTRONICS (SUZHOU) CO., LTD., Jiangsu Province (CN)

(72) Inventors: Liguo RAO, Jiangsu Province (CN); Chunlong ZHENG, Jiangsu Province (CN); Mingya LUO, Jiangsu Province (CN)

(73) Assignee: MERRY ELECTRONICS (SUZHOU) CO., LTD., Jiangsu Province (CN)

(21) Appl. No.: 19/251,270

(22) Filed: Jun. 26, 2025

(30) Foreign Application Priority Data
Jul. 1, 2024 (CN) 202410874454.5

(51) Int. Cl. H04R 9/02; H04R 1/06; H04R 7/04; H04R 7/18; H04R 9/04; H04R 9/06

(52) U.S. Cl. CPC H04R 9/025; H04R 1/06; H04R 7/04; H04R 7/18; H04R 9/045; H04R 9/06; H04R 2400/11

(57) ABSTRACT

A loudspeaker includes a magnetic circuit system and a vibration system. The magnetic circuit system includes a central magnetic component and a magnetic frame component for forming a magnetic gap. The vibration system includes a voice coil suspended in the magnetic gap, as well as a first diaphragm and a second diaphragm fixed to the magnetic frame component. Damping rubber blocks are provided in receiving grooves of the magnetic frame component to fix lead-out wires of the voice coil, and the lead-out wires extend outward through wiring ports on the magnetic frame component. As a result, the loudspeaker solves the problem of diaphragm rocking vibration.

### CLAIM OF PRIORITY AND CROSS-REFERENCE TO RELATED APPLICATION(S)

This application claims the benefit of Chinese Patent Application No. 202410874454.5, filed on Jul. 1, 2024, which is incorporated herein by reference in its entirety.

### BACKGROUND OF THE DISCLOSURE

### 1. Field of the Disclosure

The present disclosure relates to the field of electroacoustic conversion technology, and particularly to a loudspeaker.

### 2. Description of the Related Art

Loudspeakers of existing electronic equipment are usually equipped with only one diaphragm. When the diaphragm vibrates with the voice coil, rolling vibration is caused due to nonlinearity, resulting in distortion and noise. At the same time, the electronic equipment equipped with a single diaphragm loudspeaker has the problem of poor call privacy.

### BRIEF DESCRIPTION OF THE DISCLOSURE

In view of this, the present disclosure provides a loudspeaker.

The embodiment of the disclosure provides a loudspeaker, which comprises: a magnetic circuit system, the magnetic circuit system including a central magnetic component and a magnetic frame component, the central magnetic component being fixed at a central position of the magnetic frame component, a magnetic gap being formed between the central magnetic component and the magnetic frame component, and the magnetic frame component being provided with wiring ports; and a vibration system, the vibration system including a first diaphragm, a second diaphragm, and a voice coil, the first diaphragm and the second diaphragm being fixed to the magnetic frame component, the first diaphragm being located above the central magnetic component, the second diaphragm being located below the central magnetic component, the voice coil being suspended in the magnetic gap, and the voice coil being connected to the first diaphragm and the second diaphragm respectively; wherein the magnetic frame component is provided with containing grooves, damping rubber blocks are disposed in the containing grooves, the damping rubber blocks fix lead-out wires of the voice coil, and the lead-out wires extend outward through the wiring ports.

In some embodiments, the magnetic frame component comprises: a first magnetic frame, the first magnetic frame being arranged around an outer side of the central magnetic component; and a second magnetic frame, the second magnetic frame being connected to a top portion of the central magnetic component and a top portion of the first magnetic frame.

In some embodiments, the first diaphragm is disposed between the first magnetic frame and the second magnetic frame; the second diaphragm is disposed at a bottom portion of the first magnetic frame.

In some embodiments, the second magnetic frame comprises: a central portion, the central portion being connected to a top portion of the central magnetic component; a second edge portion, the second edge portion being located outside the central portion and connected to a top portion of the first magnetic frame; and second connecting portions, the second connecting portions connecting the central portion and the second edge portion.

In some embodiments, a thickness of one second connecting portion is smaller than those of the central portion and the second edge portion, and upper surfaces of the second connecting portions are flush with upper surfaces of the central portion and the second edge portion.

In some embodiments, the first magnetic frame comprises: a surrounding portion, the surrounding portion being arranged around an outer side of the central magnetic component; a first edge portion, the first edge portion being located outside the surrounding portion and connected to the second edge portion; and first connecting portions, the first connecting portions connecting the surrounding portion and the first edge portion.

In some embodiments, parts of the first edge portion are protruded to form first docking portions; parts of the second edge portion are recessed to form second docking portions, the second docking portions being fixedly connected to the first docking portions.

In some embodiments, positions of the first connecting portions and the second connecting portions correspond to each other.

In some implementations, parts of the surrounding portion are recessed to form leaking grooves.

In some embodiments, parts of the first edge portion are protruded to form mounting portions; parts of the first diaphragm are disposed between the mounting portions and the second magnetic frame.

In some embodiments, a thickness of the surrounding portion is smaller than that of the first edge portion; a thickness of one first connecting portion is smaller than that of the surrounding portion.

In some embodiments, the surrounding portion, the first connecting portions, and the first edge portion cooperatively form the containing grooves.

In some embodiments, ventilating holes are formed between the first edge portion and the second edge portion.

In some embodiments, the central magnetic component comprises: a magnet; an upper plate, the upper plate being disposed on a top portion of the magnet and fixedly connected to the second magnetic frame; and a lower plate, the lower plate being disposed on a bottom portion of the magnet.

In some embodiments, the upper plate comprises: a main body portion, the main body portion being connected to the magnet; and a convex portion, the convex portion protruding upward from the main body portion and fixedly connected to the second magnetic frame.

In some embodiments, the first diaphragm comprises: a first inner ring portion, the first inner ring portion being fixedly connected to a top portion of the voice coil; a first corrugated ring portion, the first corrugated ring portion being located outside the first inner ring portion and arched downward; and a first outer ring portion, the first outer ring portion being located outside the first corrugated ring portion and fixed between the first magnetic frame and the second magnetic frame.

In some embodiments, the second diaphragm comprises: a second inner ring portion, the second inner ring portion being fixedly connected to a bottom portion of the voice coil; a second corrugated ring portion, the second corrugated ring portion being located outside the second inner ring portion and arched upward; and a second outer ring portion, the second outer ring portion being located outside the second corrugated ring portion and fixed at a bottom portion of the first magnetic frame.

In some embodiments, the vibration system further comprises: a damper, an outer edge of the damper being connected to the voice coil through the first diaphragm, and an inner edge of the damper being disposed on the central magnetic component.

In some embodiments, the damper comprises: a third inner ring portion, the third inner ring portion being fixedly connected to the central magnetic component; a third corrugated ring portion, the third corrugated ring portion being located outside the third inner ring portion and arched upward; and a third outer ring portion, the third outer ring portion being located outside the third corrugated ring portion and connected to the voice coil through the first diaphragm.

### BRIEF DESCRIPTION OF THE DRAWINGS

The above and other objectives, features, and advantages of the present disclosure will become clearer through the following description of embodiments of the present disclosure with reference to the accompanying drawings:

FIG. 1 is a schematic diagram of the structure of a loudspeaker provided in an embodiment of the present disclosure;

FIG. 2 is an exploded schematic diagram of a loudspeaker provided in an embodiment of the present disclosure;

FIG. 3 is a schematic cross-sectional view of a loudspeaker provided in an embodiment of the present disclosure;

FIG. 4 is the structural diagram of a voice coil provided by the embodiment of the disclosure;

FIG. 5 is an exploded schematic diagram of another loudspeaker provided by an embodiment of the present disclosure;

FIG. 6 is a schematic cross-sectional view of another loudspeaker provided by an embodiment of the present disclosure;

FIG. 7 is a schematic diagram of the structure of another voice coil provided by an embodiment of the present disclosure;

FIG. 8 is the structural diagram of a magnetic circuit system provided by the embodiment of the disclosure;

FIG. 9 is a schematic diagram of the structure of a second magnetic frame provided in an embodiment of the present disclosure;

FIG. 10 is the structural diagram of a first magnetic frame provided by the embodiment of the disclosure;

FIG. 11 is a schematic diagram of the structure of a upper plate provided by an embodiment of the present disclosure;

FIG. 12 is the structural diagram of a first diaphragm provided by the embodiment of the disclosure;

FIG. 13 is the structural diagram of a second diaphragm provided by the embodiment of the disclosure;

FIG. 14 is the structural diagram of a damper provided by the embodiment of the disclosure.

### DETAILED DESCRIPTION OF EMBODIMENTS OF THE DISCLOSURE

The following describes the present application based on embodiments, but the present application is not limited to these embodiments. In the following detailed description of the present application, specific details are described in detail. For those skilled in the art, the present application may be fully understood without the description of these detailed parts. To avoid confusion of the essence of the present application, the well-known methods, processes, procedures, components, and circuits have not been described in detail.

In addition, ordinary technical personnel in this field should understand that the accompanying drawings provided here are for illustrative purposes and may not necessarily be drawn to scale.

Unless otherwise specified and limited, the terms “installation”, “connection”, “coupling”, “fixation”, etc. should be broadly understood, for example, they may be fixed connections, detachable connections, or integrated; It may be a mechanical connection or an electrical connection; It may be directly connected or indirectly connected through an intermediate medium, and may be a connection within two components or an interaction relationship between two components, unless otherwise specified. For ordinary technical personnel in this field, the specific meanings of the above terms in this application may be understood according to the specific situation.

For ease of illustration, space related terms such as “inside”, “outside”, “lower”, “below”, “lower portion”, “above”, “upper portion”, etc. are used here to describe the relationship between one element or feature illustrated in the figure and another element or feature. It will be understood that space related terms may imply different orientations of the device during use or operation, apart from those depicted in the diagram. For example, if the device in the figure is flipped, the component described as being “lower” or “below” other components or features will then be positioned “above” that other component or feature. Therefore, the example term ‘below’ may encompass both the directions above and below. The device may be oriented in other ways (rotated 90 degrees or in other orientations), and the spatial descriptors used here should be explained accordingly.

Unless explicitly required by the context, words such as “including” and “containing” in the entire application document should be interpreted as containing rather than exclusive or exhaustive; That is to say, it means “including but not limited to”.

In the description of this application, it should be understood that the terms “first”, “second”, etc. are only used for descriptive purposes and cannot be understood as indicating or implying relative importance. In addition, in the description of this application, unless otherwise specified, the meaning of “multiple” refers to two or more.

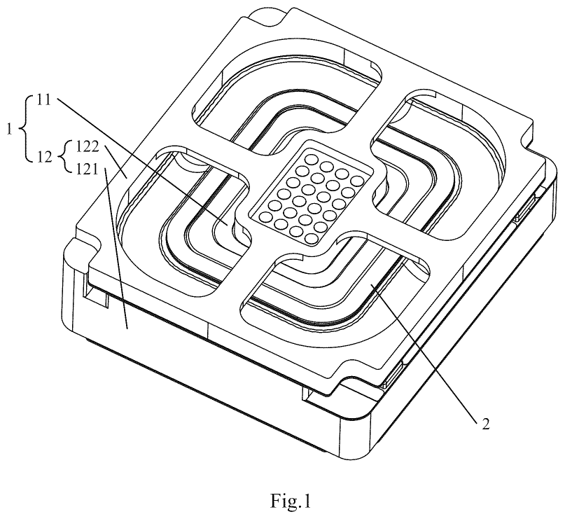

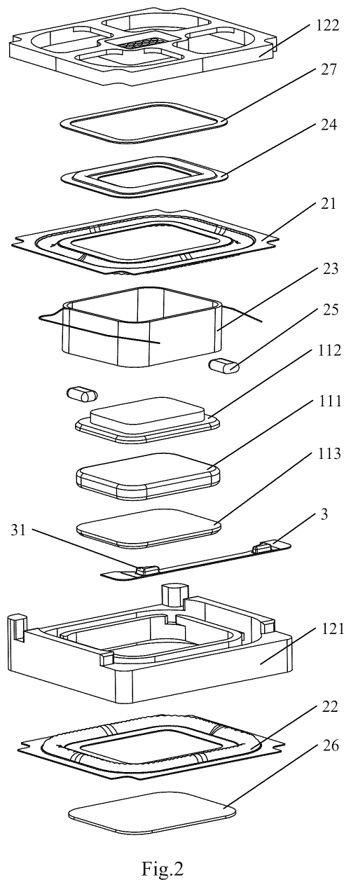

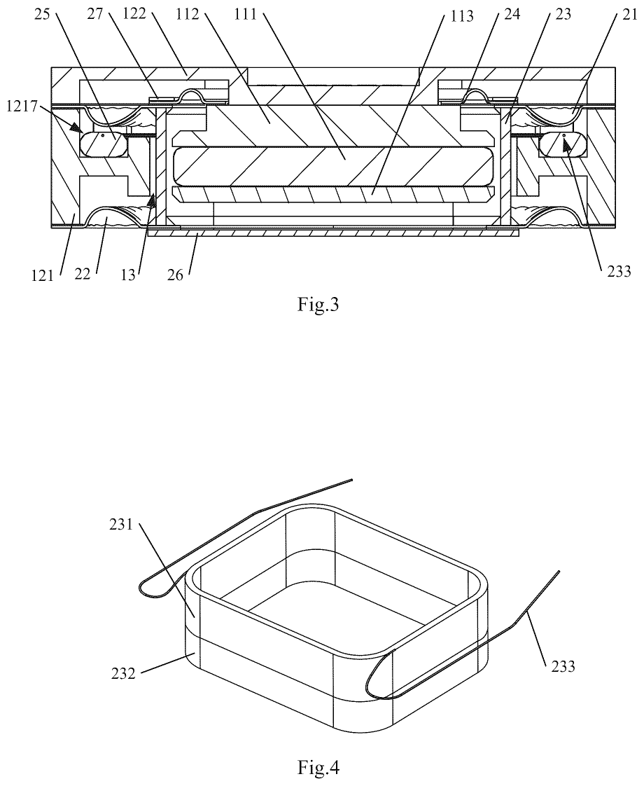

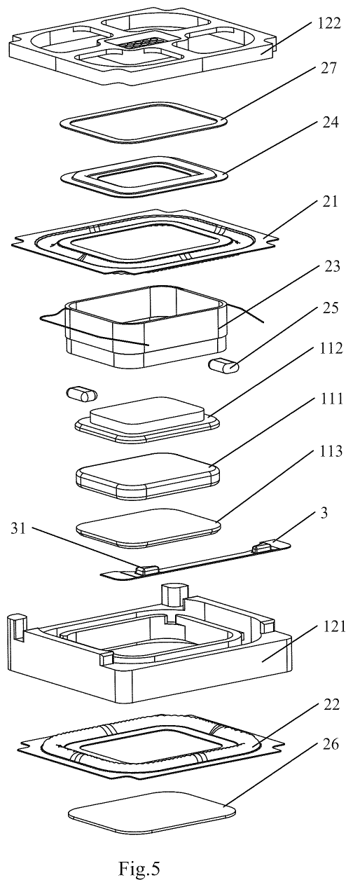

FIG. 1 is a schematic diagram of the structure of a loudspeaker provided in an embodiment of the present disclosure, FIG. 2 is an exploded schematic diagram of a loudspeaker provided in an embodiment of the present disclosure, and FIG. 3 is a schematic cross-sectional view of a loudspeaker provided in an embodiment of the present disclosure. As shown in FIGS. 1 to 3, the loudspeaker includes a magnetic circuit system 1 and a vibration system 2. Specifically, the magnetic circuit system 1 includes a central magnetic component 11 and a magnetic frame component 12. It should be noted that the magnetic frame component 12 is made of magnetic materials, such as low carbon steel, pure iron, etc. Further, the central magnetic component 11 is fixedly arranged at the central position of the magnetic frame component 12, so that a magnetic gap 13 is formed between the central magnetic component 11 and the magnetic frame component 12. It is easy to understand that the magnetic frame component 12 is surrounded by a cavity for containing the central magnetic component 11 and the vibration system 2. On the other hand, the vibration system 2 includes a first diaphragm 21, a second diaphragm 22, and a voice coil 23. Specifically, the first diaphragm 21 and the second diaphragm 22 are fixed on the magnetic frame component 12, the first diaphragm 21 is located above the central magnetic component 11, and the second diaphragm 22 is located below the central magnetic component 11. Further, the voice coil 23 is suspended in the magnetic gap 13. FIG. 4 is the structural diagram of a voice coil provided by the embodiment of the disclosure. As shown in FIG. 4, the voice coil 23 includes an upper portion 231 and a lower portion 232. It is easy to understand that the upper portion 231 of the voice coil 23 is fixedly connected with the first diaphragm 21, and the lower portion 232 of the voice coil 23 is fixedly connected with the second diaphragm 22. Thus, when the voice coil 23 reciprocates in the magnetic gap 13, it may drive the first diaphragm 21 and the second diaphragm 22 to move synchronously. It should be noted that the upper portion 231 of voice coil 23 is coiled in a first direction, and the lower portion 232 of the voice coil 23 is coiled in a second direction. It is easy to understand that the first direction and the second direction are two opposite coiling directions, that is, the first direction is clockwise and the second direction is counterclockwise, or the first direction is counterclockwise and the second direction is clockwise, so as to ensure that the voice coil 23 may stably reciprocate in the magnetic gap 13.

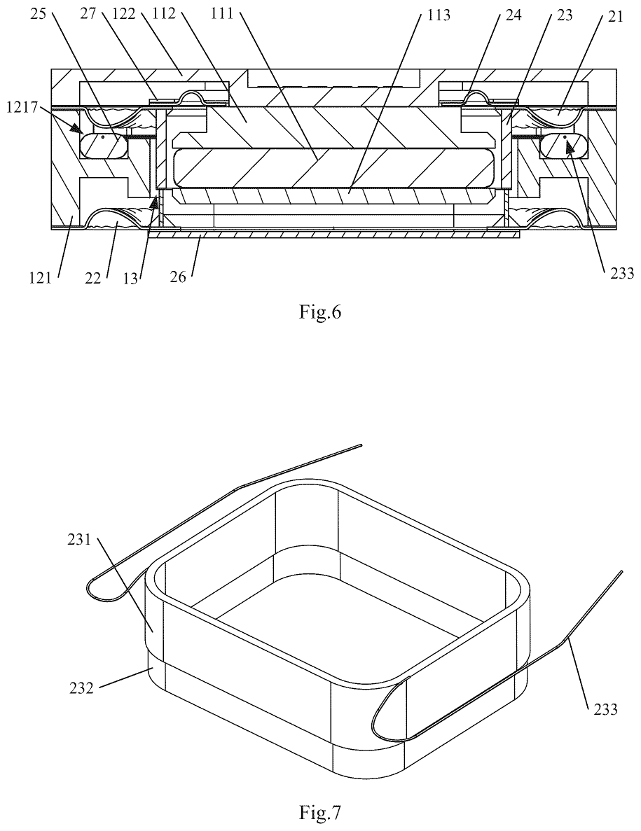

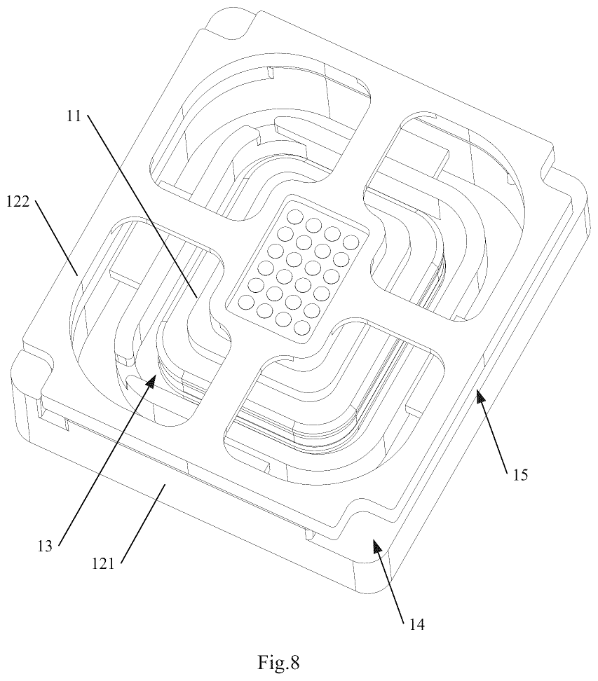

FIG. 5 is an exploded schematic diagram of another loudspeaker provided by an embodiment of the present disclosure, FIG. 6 is a schematic cross-sectional view of another loudspeaker provided by an embodiment of the present disclosure, and FIG. 7 is a schematic diagram of the structure of another voice coil provided by an embodiment of the present disclosure. As shown in FIGS. 5 to 7, the structure of voice coil 23 may also be adjusted to meet the needs of stable movement of vibration system 2. Specifically, the lower portion 232 of the voice coil 23 may be set as a fixed member, which is a ring structure and is directly bonded with the upper portion 231 of the voice coil 23, so that the coiling direction of the voice coil 23 does not need to be changed. As an optional embodiment, the lower portion part 232 of the voice coil 23 may also be kept unchanged, while the upper portion 231 of the voice coil 23 may be replaced with a fixed member.

As a result, the magnetic frame component 12 not only plays a role of magnetic conductivity, but also supports the central magnetic component 11 and the vibration system 2. Furthermore, by setting the first diaphragm 21 and the second diaphragm 22, the loudspeaker solves the problem of diaphragm rolling to avoid distortion or noise. At the same time, since the voice coil 23 is at the absolute center of the magnetic circuit, the symmetry and flatness of BL curve are better. In addition, by setting the first diaphragm 21 and the second diaphragm 22, the loudspeaker may be matched with the overall system design, so that the electronic equipment may more conveniently achieve the purpose of protecting the privacy of calls.

In one embodiment, since the upper portion 231 of the voice coil 23 is coiled in the first direction while the lower portion 232 of the voice coil 23 is coiled in the second direction, a number of turns of the upper portion 231 is greater than or equal to a number of turns of the lower portion 232, so that the voice coil 23 may adapt to the magnetic field formed by the magnetic circuit system 1 for stable reciprocating motion. It is easy to understand that the turns of the upper portion 231 and the turns of the lower portion 232 may be adjusted according to actual needs. For example, the ratio of the number of turns of the upper portion 231 to the number of turns of the lower portion 232 may be set to 5:5, 6:4, or 7:3. In another embodiment, since the lower portion 232 of the voice coil 23 is set as a fixed member, the height of the fixed member relative to the entire voice coil 23 may be adjusted as required.

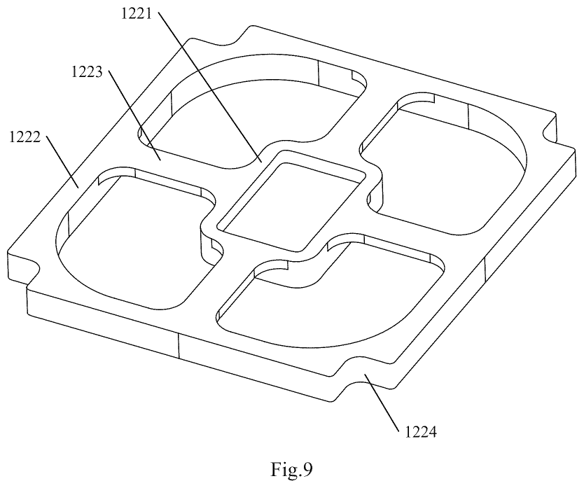

FIG. 8 is the structural diagram of a magnetic circuit system provided by the embodiment of the disclosure. As shown in FIGS. 2 to 8, in one embodiment, the magnetic frame component 12 includes a first magnetic frame 121 and a second magnetic frame 122. Specifically, the first magnetic frame 121 is arranged around an outer side of the central magnetic component 11, and has a certain distance with the central magnetic component 11 to form the magnetic gap 13. Further, the second magnetic frame 122 is connected to a top portion of the central magnetic component 11 and a top portion of the first magnetic frame 121, so that the magnetic frame component 12 may synchronously realize the functions of magnetic conduction and support. As shown in FIG. 3 and FIG. 6, the first diaphragm 21 is arranged between the first magnetic frame 121 and the second magnetic frame 122, while the second diaphragm 22 is arranged at a bottom portion of the first magnetic frame 121, so that it may move synchronously under the action of the voice coil 23.

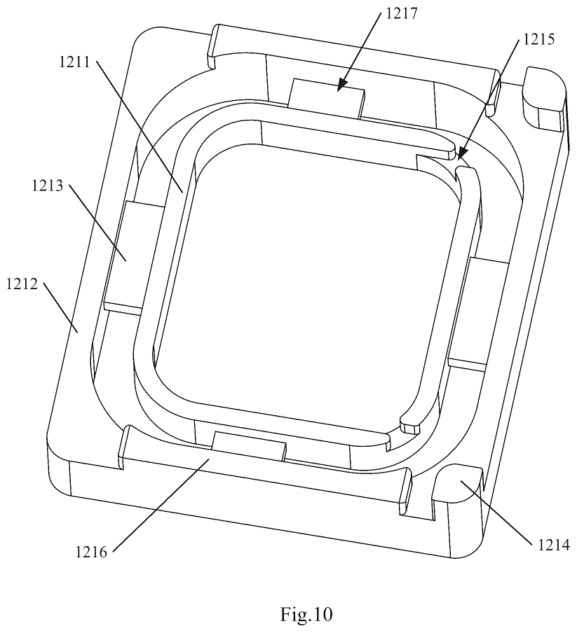

FIG. 9 is a schematic diagram of the structure of a second magnetic frame provided in an embodiment of the present disclosure. As shown in FIG. 9, in one embodiment, the second magnetic frame 122 includes a central portion 1221, a second edge portion 1222, and second connecting portions 1223. Specifically, as shown in FIGS. 3, 6 and 9, the central portion 1221 is connected to a top portion of the central magnetic component 11, the second edge portion 1222 set as a frame is located outside the central portion 1221 and connected to a top portion of the first magnetic frame 121, and the second connecting portions 1223 are connected to the central portion 1221 and the second edge portion 1222 respectively. Thus, the second magnetic frame 122 may connect the first magnetic frame 121 and the central magnetic component 11 to form the magnetic gap 13. It should be noted that the structure of the second magnetic frame 122 may be adjusted according to the loudspeaker structure, corresponding to that the overall loudspeaker is a rectangular structure, the central portion 1221 is set as a rectangular structure, and the second edge portion 1222 is set as a rectangular frame structure. It should be further explained that the number and position of the second connecting portions 1223 may be adjusted as needed. Corresponding to the overall rectangular structure of the loudspeaker, the second connecting portions 1223 are set to four and distributed in a cross shape to ensure connection strength.

As shown in FIGS. 3, 6 and 9, in one embodiment, a thickness of one second connecting portion 1223 is less than a thickness of the central portion 1221 and a thickness of the second edge portion 1222, and upper surfaces of the second connecting portions 1223 are flush with an upper surface of the central portion 1221 and an upper surface of the second edge portion 1222. Thus, the second magnetic frame 122 located at the top of the loudspeaker may ensure the flatness of the top structure of the loudspeaker, so as to install the loudspeaker in various electronic devices. At the same time, a concave structure may be formed at the bottom of the second magnetic frame 122 to leave enough movement space for the vibration system 2.

FIG. 10 is the structural diagram of a first magnetic frame provided by the embodiment of the disclosure. As shown in FIG. 10, in one embodiment, the first magnetic frame 121 includes a surrounding portion 1211, a first edge portion 1212, and first connecting portions 1213. Specifically, as shown in FIGS. 3, 6 and 10, the surrounding portion 1211 set as a frame is arranged around an outer side of the central magnetic component 11, and has a certain distance with the central magnetic component 11 to form the magnetic gap 13. Further, the first edge portion 1212 set as a frame is located outside the surrounding portion 1211 and connected with the second edge portion 1222. It is easy to understand that the shape and size of the first edge portion 1212 and the second edge portion 1222 match each other. Further, the first connecting portions 1213 connect the surrounding portion 1211 and the first edge portion 1212. Thus, the magnetic frame component 12 may cooperate with the central magnetic component 11 to form the magnetic gap 13 through the first magnetic frame 121 and the second magnetic frame 122.

As shown in FIG. 8, in one embodiment, the positions of the first connecting portions 1213 and the second connecting portions 1223 match each other. That is to say, there are four first connecting portions 1213, and the four first connecting portions 1213 are arranged in a cross shape to correspond one-to-one with the second connecting portions 1223. Therefore, the connection strength of the first connecting portions 1213 to the surrounding portion 1211 and the first edge portion 1212 may be guaranteed, and the structural strength of the magnetic frame component 12, that is, the structural strength of the entire loudspeaker, may also be guaranteed.

As shown in FIGS. 8 to 10, in one embodiment, first docking portions 1214 are formed on parts of the first edge portion 1212, while second docking portions 1224 are formed on parts of the second edge portion 1222. Thus, the first docking portions 1214 and the second docking portions 1224 may pair with each other to realize fixed connection, thus realizing the fixed connection of the first magnetic frame 121 and the second magnetic frame 122. Optionally, the first docking portions 1214 and the second docking portions 1224 are connected by welding. It should be noted that the first docking portions 1214 are provided with two and are located at two adjacent corners of the first edge portion 1212, so that the magnetic circuit system 1 may form a suitable magnetic circuit after the first magnetic frame 121 is connected to the second magnetic frame 122. It should be further noted that the second docking portions 1224 are provided with four and located at the four corners of the second edge portion 1222, so that the second magnetic frame 122 is shaped into a symmetrical structure, which is helpful for production molding and cost reduction.

As shown in FIGS. 3, 6 and 10, in one embodiment, parts of the first edge portion 1212 are raised to form mounting portions 1216. It should be noted that the mounting portions 1216 are provided with two and are in a strip structure as a whole, and the two mounting portions are located on two opposite sides of the first edge portion 1212. Further, parts of the first diaphragm 21 are arranged between the mounting portions 1216 and the second magnetic frame 122. That is to say, the first magnetic frame 121 clamps the first diaphragm 21 together with the second magnetic frame 122 through the mounting portions 1216 to prevent the first diaphragm 21 from falling off.

As shown in FIG. 8, in one embodiment, wiring ports 14 are formed between the first edge portion 1212 and the second edge portion 1222, that is, wiring ports 14 are formed on the magnetic frame component 12. Specifically, the wiring ports 14 are provided with two and are located at two corners opposite to the first docking portions 1214. It is easy to understand that the voice coil 23 may be connected to the external audio circuit through the wiring ports 14.

As shown in FIG. 4 and FIG. 7, in one embodiment, the voice coil 23 has lead-out wires 233, and the lead-out wires 233 extends through the wiring ports 14, so as to connect the external audio circuit through the wiring ports 14. Further, parts of the area on the surrounding portion 1211 are recessed to form leaking grooves 1215. It is easy to understand that the leaking grooves 1215 may avoid the lead-out wires 233, so that the voice coil 23 may connect to the external audio circuit through the lead-out wires 233. It should be noted that there are two corresponding lead-out wires 233 and two leaking grooves 1215, and the positions of leaking grooves 1215 are close to the wiring ports 14.

As shown in FIGS. 3, 6 and 10, in one embodiment, the thickness of the surrounding portion 1211 is less than that of the first edge portion 1212, and the thickness of one first connecting portion 1213 is less than that of the surrounding portion 1211. Therefore, the first magnetic frame 121 may avoid the first diaphragm 21 and the second diaphragm 22, so as to avoid affecting the vibration of the first diaphragm 21 and the second diaphragm 22.

As shown in FIGS. 3, 6 and 10, in one embodiment, the surrounding portion 1211, the first connecting portions 1213 and the first edge portion 1212 form containing grooves 1217. Further, the containing grooves 1217 are provided with damping rubber blocks 25. It should be noted that the damping rubber blocks 25 are used to fix the lead-out wires 233, so as to avoid disturbance of the lead-out wires 233 when the voice coil 23 vibrates. It should be further explained that, since there are two lead-out wires 233, two damping rubber blocks 25 are provided.

As shown in FIG. 2 and FIG. 5, in one embodiment, the loudspeaker further includes an electrical connector 3. It should be noted that the electrical connector 3 is located on the magnetic frame component 12 and on the side where the wiring ports 14 are located. Optionally, the electrical connector 3 may be set as a circuit board. Further, the lead-out wires 233 are welded to the electrical connector 3, so as to realize the electrical connection between the voice coil 23 and the electrical connector 3, so that the voice coil 23 may be connected to the external audio circuit. Further, the electrical connector 3 is provided with protective colloids 31 to protect the welding points.

As shown in FIG. 8, in one embodiment, ventilating holes 15 are formed between the first edge portion 1212 and the second edge portion 1222. Specifically, the ventilating holes 15 are provided with two and are located at two adjacent sides of the mounting portions 1216. It should be noted that the ventilating holes 15 connect the internal cavity of the loudspeaker, allowing air to circulate to achieve space cooling function, thus ensuring the sound quality of the loudspeaker.

As shown in FIGS. 2 to 3 and FIGS. 5 to 6, in one embodiment, the central magnetic component 11 includes a magnet 111, an upper plate 112, and a lower plate 113. The magnet 111 is arranged in a cuboid structure, and the structure of the upper plate 112 and the structure of the lower plate 113 are adapted to the magnet 111. It should be noted that the upper plate 112 and the lower plate 113 are made of magnetic conductive materials. Further, the upper plate 112 is arranged on the top of the magnet 111 and is fixedly connected with the second magnetic frame 122. It is easy to understand that the upper plate 112 is fixedly connected to the central portion 1221 of the second magnetic frame 122. Optionally, the upper plate 112 is connected to the central portion 1221 by welding to ensure connection strength. Optionally, a groove is provided at the top of the central portion 1221 for positioning laser welding. Further, the lower plate 113 is arranged at the bottom of the magnet 111. Thus, the central magnetic component 11 may form a suitable magnetic circuit with the magnetic frame component 12.

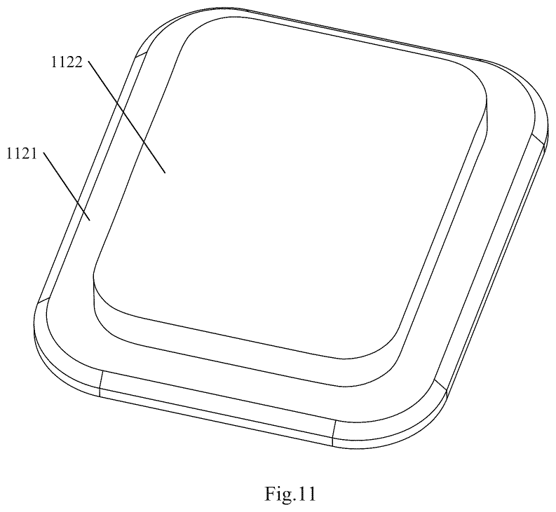

FIG. 11 is a schematic diagram of the structure of a upper plate provided by an embodiment of the present disclosure. As shown in FIG. 11, in one embodiment, the upper plate 112 includes a main body portion 1121 and a convex portion 1122. Specifically, the bottom of the main body portion 1121 is connected with the magnet 111. Further, the top of the main body portion 1121 protrudes upward to form the convex portion 1122, and the convex portion 1122 is used for fixedly connecting with the central portion 1221 of the second magnetic frame 122. Thus, the upper plate 112 may meet the requirements of magnetic conductivity and connection.

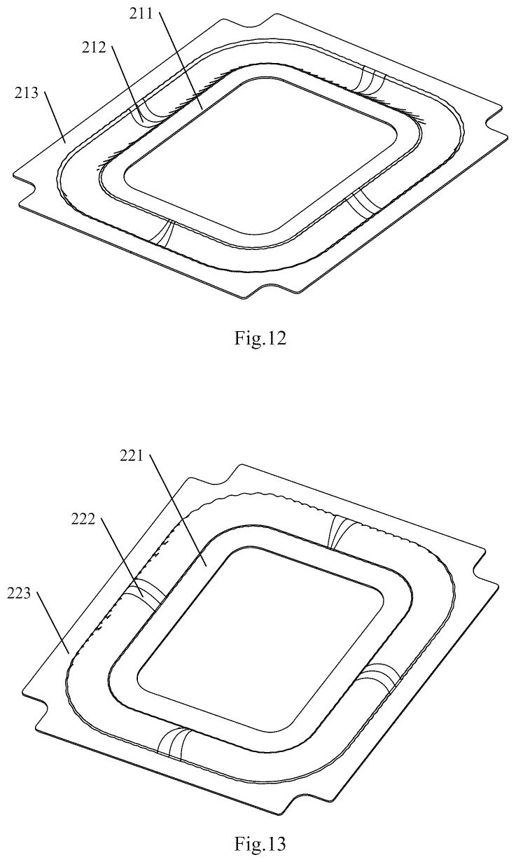

FIG. 12 is the structural diagram of a first diaphragm provided by the embodiment of the disclosure. As shown in FIG. 12, in one embodiment, the first diaphragm 21 includes a first inner ring portion 211, a first corrugated ring portion 212, and a first outer ring portion 213. As shown in FIGS. 3, 6 and 12, the first inner ring portion 211 is fixedly connected to the top of the voice coil 23, that is, to the upper portion 231 of the voice coil 23. Furthermore, the first corrugated ring portion 212 is located on the outer side of the first inner ring portion 211 and arches downward. Further, the first outer ring portion 213 is located outside the first corrugated ring portion 212, and is fixed between the first magnetic frame 121 and the second magnetic frame 122. It is easy to understand that part of the first outer ring portion 213 is between the second edge portion 1222 of the second magnetic frame 122 and the mounting portions 1216. Therefore, the first diaphragm 21 is installed between the first magnetic frame 121 and the second magnetic frame 122. Optionally, the lower surface of the first inner ring portion 211 is connected to the upper portion 231 of the voice coil 23 by gluing, the upper surface of the first outer ring portion 213 is connected to the second edge portion 1222 by gluing, and some areas of the lower surface of the first outer ring portion 213 are connected to the mounting portions 1216 by gluing.

FIG. 13 is the structural diagram of a second diaphragm provided by the embodiment of the disclosure. As shown in FIG. 13, in one embodiment, the second diaphragm 22 includes a second inner ring portion 221, a second corrugated ring portion 222, and a second outer ring portion 223. As shown in FIGS. 3, 6 and 13, the second inner ring portion 221 is fixedly connected to the bottom of the voice coil 23, that is, to the lower portion 232 of the voice coil 23. Furthermore, the second corrugated ring portion 222 is located on the outer side of the second inner ring portion 221 and arches downward. Further, the second outer ring portion 223 is located on the outside of the second corrugated ring portion 222 and is fixed at the bottom of the first magnetic frame 121. Optionally, the upper surface of the second inner ring portion 221 is connected to the lower portion 232 of the voice coil 23 by adhesive, and the upper surface of the second outer ring portion 223 is connected to the lower surface of the first edge portion 1212 by adhesive. Therefore, the installation of the second diaphragm 22 is realized.

As shown in FIGS. 2 to 3 and FIGS. 5 to 6, in one embodiment, the vibration system 2 also includes a central patch 26. Specifically, the central patch 26 is arranged at the bottom of the second diaphragm 22. More specifically, the central patch 26 is connected to the second inner ring portion 221, so that it is arranged at the center of the second diaphragm 22. It is easy to understand that the central patch 26 may provide rigidity for the second diaphragm 22 to ensure the acoustic performance of the loudspeaker. Optionally, the upper surface of the central patch 26 is connected to the lower surface of the second inner ring portion 221 by adhesive.

As shown in FIGS. 2 to 3 and FIGS. 5 to 6, in one embodiment, the vibration system 2 also includes a damper 24. Specifically, the outer edge of the damper 24 is connected with the voice coil 23 through the first diaphragm 21, and the inner edge of the damper 24 is arranged on the central magnetic component 11, that is, the inner edge of the damper 24 is arranged on the convex portion 1122 of the upper plate 112. It is easy to understand that by setting the damper 24, the balance of the vibration system 2 may be supported, and the damper 24 may also control the compliance of the vibration system 2.

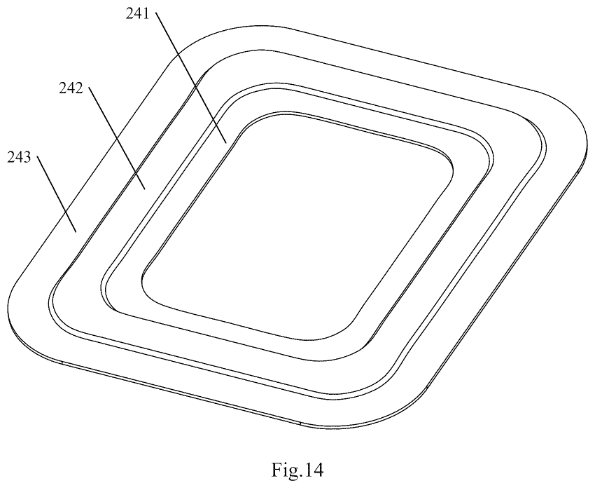

FIG. 14 is the structural diagram of a damper provided by the embodiment of the disclosure. As shown in FIG. 14, in one embodiment, the damper 24 includes a third inner ring portion 241, a third corrugated ring portion 242, and a third outer ring portion 243. As shown in FIGS. 3, 6 and 14, the third inner ring portion 241 is fixedly connected with the central magnetic component 11, that is, it is fixedly connected with the convex portion 1122 of the upper plate 112. Furthermore, the third corrugated ring portion 242 is located outside the third inner ring portion 241 and arches upwards. Further, the third outer ring portion 243 is located outside the third corrugated ring portion 242, and is connected with the voice coil 23 through the first diaphragm 21. Optionally, the lower surface of the third inner ring portion 241 is connected to the upper surface of the convex portion 1122 by adhesive, and the lower surface of the third outer ring portion 243 is connected to the upper surface of the first inner ring portion 211 by adhesive. In other words, the first diaphragm 21 and the damper 24 are synchronously connected to the voice coil 23.

As shown in FIGS. 2 to 3 and FIGS. 5 to 6, in one embodiment, the vibration system 2 includes a reinforcing member 27. Specifically, the reinforcing member 27 is arranged in a ring shape and is arranged on the third outer ring portion 243. It is easy to understand that the connection strength of the damper 24 and the first diaphragm 21 with the voice coil 23 may be improved by setting the reinforcing member 27. Optionally, the reinforcing member 27 is connected to the upper surface of the third outer ring portion 243 by adhesive.

The embodiments of the present disclosure also provide an electronic device, which may be a mobile phone, a tablet computer, a smart watch, etc., without limitation. The electronic device is equipped with a loudspeaker as described earlier, which may improve sound quality and protect call privacy, thereby enhancing the user experience.

The embodiments of the present disclosure disclose a loudspeaker and an electronic device. The loudspeaker includes a magnetic circuit system and a vibration system. The magnetic circuit system includes a central magnetic component and a magnetic frame component for forming a magnetic gap. The vibration system includes a voice coil suspended in the magnetic gap, as well as a first diaphragm and a second diaphragm fixed to the magnetic frame component. The first diaphragm is located above the central magnetic component, the second diaphragm is located below the central magnetic component, and the voice coil is connected to the first diaphragm and the second diaphragm respectively. Damping rubber blocks are provided in containing grooves of the magnetic frame component to fix lead-out wires of the voice coil, and the lead-out wires extend outward through wiring ports on the magnetic frame component. The arrangement of the damping rubber blocks prevents disturbance or breakage of the lead-out wires during vibration of the voice coil. As a result, the loudspeaker solves the problem of diaphragm rocking vibration. Additionally, since the voice coil is positioned at the absolute center of the magnetic circuit, the symmetry and flatness of the BL curve are improved, and the electronic device achieves the purpose of protecting call privacy.

The above description is only a preferred embodiment of the present application and is not intended to limit the present application. For those skilled in the art, the present application may have various modifications and variations. Any modifications, equivalent substitutions, improvements, etc. made within the spirit and principles of this application may be included within the scope of protection of this application.

What is claimed is:

1. A loudspeaker, comprising:
a magnetic circuit system, the magnetic circuit system including a central magnetic component and a magnetic frame component, the central magnetic component being fixed at a central position of the magnetic frame component, a magnetic gap being formed between the central magnetic component and the magnetic frame component, and the magnetic frame component being provided with wiring ports; and
a vibration system, the vibration system including a first diaphragm, a second diaphragm, and a voice coil, the first diaphragm and the second diaphragm being fixed to the magnetic frame component, the first diaphragm being located above the central magnetic component, the second diaphragm being located below the central magnetic component, the voice coil being suspended in the magnetic gap, and the voice coil being connected to the first diaphragm and the second diaphragm respectively;
wherein the magnetic frame component is provided with containing grooves, damping rubber blocks are disposed in the containing grooves, the damping rubber blocks fix lead-out wires of the voice coil, and the lead-out wires extend outward through the wiring ports.

2. The loudspeaker according to claim 1, wherein the magnetic frame component comprises:
a first magnetic frame, the first magnetic frame being arranged around an outer side of the central magnetic component; and
a second magnetic frame, the second magnetic frame being connected to a top portion of the central magnetic component and a top portion of the first magnetic frame.

3. The loudspeaker according to claim 2, wherein the first diaphragm is disposed between the first magnetic frame and the second magnetic frame;
the second diaphragm is disposed at a bottom portion of the first magnetic frame.

4. The loudspeaker according to claim 2, wherein the second magnetic frame comprises:
a central portion, the central portion being connected to a top portion of the central magnetic component;
a second edge portion, the second edge portion being located outside the central portion and connected to a top portion of the first magnetic frame; and
second connecting portions, the second connecting portions connecting the central portion and the second edge portion.

5. The loudspeaker according to claim 4, wherein a thickness of one second connecting portion is smaller than those of the central portion and the second edge portion, and upper surfaces of the second connecting portions are flush with upper surfaces of the central portion and the second edge portion.

6. The loudspeaker according to claim 4, wherein the first magnetic frame comprises:
a surrounding portion, the surrounding portion being arranged around an outer side of the central magnetic component;
a first edge portion, the first edge portion being located outside the surrounding portion and connected to the second edge portion; and
first connecting portions, the first connecting portions connecting the surrounding portion and the first edge portion.

7. The loudspeaker according to claim 6, wherein parts of the first edge portion are protruded to form first docking portions;
parts of the second edge portion are recessed to form second docking portions, the second docking portions being fixedly connected to the first docking portions.

8. The loudspeaker according to claim 6, wherein positions of the first connecting portions and the second connecting portions correspond to each other.

9. The loudspeaker according to claim 6, wherein parts of the surrounding portion are recessed to form leaking grooves.

10. The loudspeaker according to claim 6, wherein parts of the first edge portion are protruded to form mounting portions;
parts of the first diaphragm are disposed between the mounting portions and the second magnetic frame.

11. The loudspeaker according to claim 6, wherein a thickness of the surrounding portion is smaller than that of the first edge portion;
a thickness of one first connecting portion is smaller than that of the surrounding portion.

12. The loudspeaker according to claim 11, wherein the surrounding portion, the first connecting portions, and the first edge portion cooperatively form the containing grooves.

13. The loudspeaker according to claim 6, wherein ventilating holes are formed between the first edge portion and the second edge portion.

14. The loudspeaker according to claim 2, wherein the central magnetic component comprises:
a magnet;
an upper plate, the upper plate being disposed on a top portion of the magnet and fixedly connected to the second magnetic frame; and
a lower plate, the lower plate being disposed on a bottom portion of the magnet.

15. The loudspeaker according to claim 14, wherein the upper plate comprises:
a main body portion, the main body portion being connected to the magnet; and
a convex portion, the convex portion protruding upward from the main body portion and fixedly connected to the second magnetic frame.

16. The loudspeaker according to claim 3, wherein the first diaphragm comprises:
a first inner ring portion, the first inner ring portion being fixedly connected to a top portion of the voice coil;
a first corrugated ring portion, the first corrugated ring portion being located outside the first inner ring portion and arched downward; and
a first outer ring portion, the first outer ring portion being located outside the first corrugated ring portion and fixed between the first magnetic frame and the second magnetic frame.

17. The loudspeaker according to claim 3, wherein the second diaphragm comprises:
a second inner ring portion, the second inner ring portion being fixedly connected to a bottom portion of the voice coil;
a second corrugated ring portion, the second corrugated ring portion being located outside the second inner ring portion and arched upward; and
a second outer ring portion, the second outer ring portion being located outside the second corrugated ring portion and fixed at a bottom portion of the first magnetic frame.

18. The loudspeaker according to claim 3, wherein the vibration system further comprises:
a damper, an outer edge of the damper being connected to the voice coil through the first diaphragm.

19. The loudspeaker according to claim 18, wherein an inner edge of the damper being disposed on the central magnetic component.

20. The loudspeaker according to claim 19, wherein the damper comprises:
a third inner ring portion, the third inner ring portion being fixedly connected to the central magnetic component;
a third corrugated ring portion, the third corrugated ring portion being located outside the third inner ring portion and arched upward; and
a third outer ring portion, the third outer ring portion being located outside the third corrugated ring portion and connected to the voice coil through the first diaphragm.
